(19) United States
(12) Patent Application Publication
(10) Pub. No.: US 2025/0330549 A1
(43) Pub. Date: Oct. 23, 2025

(54) EXTRACTION DEVICE, EXTRACTION METHOD, AND NON-TRANSITORY COMPUTER-READABLE RECORDING MEDIUM

(71) Applicant: Konica Minolta, Inc., Tokyo (JP)

(72) Inventors: Haruka KURUMAYA, Saitama (JP); Natsuko MINEGISHI, Tokyo (JP)

(21) Appl. No.: 19/176,789

(22) Filed: Apr. 11, 2025

(30) Foreign Application Priority Data
Apr. 19, 2024 (JP) 2024-068446

(51) Int. Cl. H04N 1/60; G06F 3/12; G06T 7/90; G06V 10/56

(52) U.S. Cl. CPC H04N 1/60; G06F 3/1208; G06T 7/90; G06V 10/56; G06T 2207/10024

(57) ABSTRACT

An extraction device includes a hardware processor that acquires information on an attention portion by a human in image information based on image data, and the hardware processor extracts, based on the information on the attention portion, a color measurement portion of an image formed by an image forming apparatus based on the image data.

### CROSS REFERENCE TO RELATED APPLICATIONS

The entire disclosure of Japanese patent Application No. 2024-068446, filed on Apr. 19, 2024, is incorporated herein by reference in its entirety.

### BACKGROUND

### Technological Field

The present invention relates to an extraction device, an extraction method, and a non-transitory computer-readable recording medium.

### Description of Related Art

In print processing by an image forming apparatus, color stability in continuous output is required. However, since the color changes over time in the printing process, color adjustment is required. Generally, color adjustment is performed by printing a color chart in which patches for color adjustment are arranged and measuring the color of the color chart with a sensor (a color measurement section) of the image forming apparatus or an external color measurement device. A colorimetric value obtained by measuring the color of the color chart is compared with a reference value, and color adjustment is performed based on a difference between the colorimetric value and the reference value.

In addition, Japanese Unexamined Patent Publication No. 2019-149639 discloses a configuration in which, instead of a color chart, a color measurement target region is extracted from a printed image, and the color measurement of the color measurement target region is performed by a sensor of an image forming apparatus to perform color adjustment. In this configuration, for the extraction of the color measurement target region, a region (region suitable for color measurement) having a small density change is calculated as the flatness from the printed image, and the color measurement portion is extracted.

### SUMMARY

However, a portion extracted as a region suitable for color measurement by the apparatus as in the configuration described in Japanese Unexamined Patent Publication No. 2019-149639 is different from a portion that a human pays attention in an image in some cases. Since a color variation in a place that a human pays attention is highly recognizable by a human, there is a risk that an appropriate color measurement portion cannot be extracted with the configuration described in Japanese Unexamined Patent Publication No. 2019-149639.

An object of the present invention is to provide an extraction device, an extraction method, and a non-transitory computer-readable recording medium capable of extracting an appropriate color measurement portion.

In order to realize at least one of the above-described objects, an extraction device reflecting one aspect of the present invention includes a hardware processor that acquires information on an attention portion by a human in image information based on image data, in which the hardware processor extracts, based on the information on the attention portion, a color measurement portion of an image formed by an image forming apparatus based on the image data.

In order to realize at least one of the above-described objects, an extraction method reflecting an aspect of the present invention is an extraction method by an extraction device and includes: acquiring information on an attention portion by a human in image information based on image data; and extracting, based on the information on the attention portion, a color measurement portion of an image formed by an image forming apparatus based on the image data.

In order to achieve at least one of the above-described objects, a non-transitory computer-readable recording medium according to an aspect of the present invention is a non-transitory computer-readable recording medium storing an extraction program to be executed by an extraction device, the extraction program causing a computer to execute: processing of acquiring information on an attention portion by a human in image information based on image data; and processing of extracting, based on the information on the attention portion, a color measurement portion of an image formed by an image forming apparatus based on the image data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating an extraction system including an extraction device according to an embodiment of the present invention;

FIG. 2 illustrates an example of image information;

FIG. 3 illustrates a display example of information on attention portions in the extraction device;

FIG. 4 illustrates a display example of the information regarding the color measurement of the first image in the extraction device;

FIG. 5 is a flowchart illustrating an operation example of extraction control in the extraction device;

FIG. 6 is a block diagram illustrating an extraction system including an extraction device according to a modification example;

FIG. 7 is a flowchart illustrating an operation example of extraction control in the extraction device according to the modification example;

FIG. 8 illustrates a display example of information on a color measurement interval in the extraction device; and

FIG. 9 is a flowchart illustrating an operation example of color measurement interval calculation control in an extraction device according to a modification example.

### DETAILED DESCRIPTION OF EMBODIMENTS

Hereinafter, one or more embodiments of the present invention will be described with reference to the drawings. However, the scope of the invention is not limited to the disclosed embodiments.

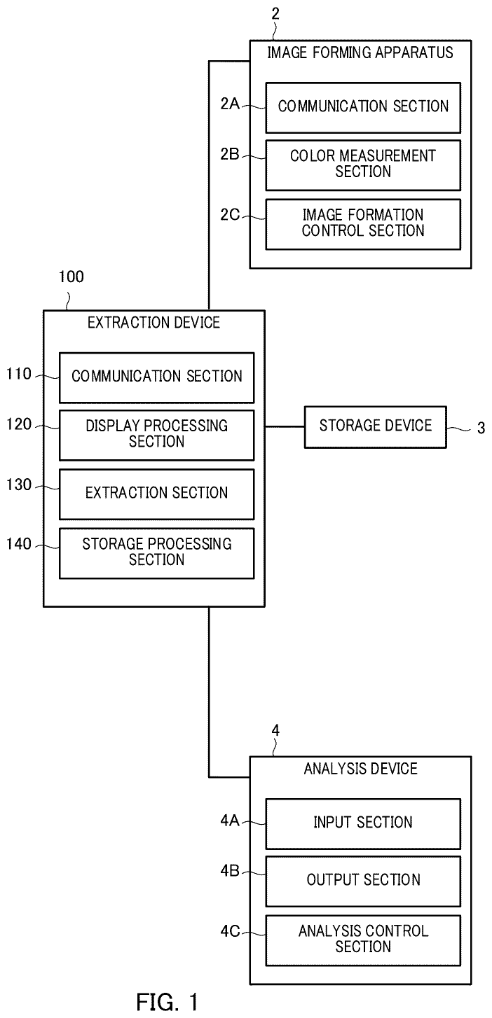

Hereinafter, an embodiment of the present invention will be described in detail with reference to the drawings. FIG. 1 is a block diagram which shows an extraction system 1 including an extraction device according to an embodiment of the present invention.

As illustrated in FIG. 1, the extraction system 1 is a system that extracts a color measurement portion of a printed image formed by an image forming apparatus 2, and includes the image forming apparatus 2, a storage device 3, an analysis device 4, and the extraction device 100.

The image forming apparatus 2 is an apparatus capable of continuously forming images on a plurality of recording media, and is connected to the extraction device 100 via a known network. The image forming apparatus 2 includes a communication section 2A, a color measurement section (i.e., color measurer) 2B, and an image formation control section 2C, in addition to an image forming section having an image forming function.

The communication section 2A transmits image information based on a predetermined image data to the extraction device 100 via a network, and receives information on a color measurement portion from the extraction device 100.

The color measurement section 2B is a color measurement device such as a scanner connected to the image forming apparatus 2. The color measurement section 2B performs color measurement on printed images on recording media with the images formed by the image forming apparatus 2 at a color measurement interval set in advance. The color measurement interval is an interval (the number of sheets of recording medium) from when color measurement is performed in a print job to when the next color measurement is performed. For example, when the color measurement interval is set to 10 sheets, color measurement by the color measurement section 2B is performed every time 10 sheets are printed in the print job.

The image forming controller 2C includes a central processing section (CPU), a read only memory (ROM), a random access memory (RAM), and the like. The CPU reads a program according to processing contents from the ROM, develops the program in the RAM, and cooperates with the developed program to centrally control operations of blocks and the like of the image forming apparatus 2. The image formation control section 2C controls color measurement processing in the color measurement section 2B in addition to image formation processing in the image forming section.

To be specific, the image formation control section 2C controls the color measurement section 2B to measure the color of a color measurement portion extracted by the extraction device 100 in a first image (printed image) formed by the image forming section. Then, the image formation control section 2C executes correction processing of a second image formed after the first image based on the color measurement information on the color measurement portion of the first image. More specifically, when the difference between the colorimetric value of a color measurement portion of the first image and a reference value (reference information) exceeds an allowable range, the image forming controller 2C executes correction processing for the second image so that the color value of the image data corresponding to the colorimetric value would be the reference value upon printed on a recording medium.

The reference information is information indicating a reference color value in the color value of the printed image on the recording medium on which the image is formed. The reference information may be, for example, a colorimetric value of a printed image on the first recording medium in the print job or a value defined based on the image data.

The allowable range is an allowable range in the deviation amount with respect to the reference value, and is a range that can be appropriately set by the user or an apparatus or a device.

The correction processing of the second image is a process of correcting the image data so as to cancel the difference between the colorimetric value and the reference value. The correction processing of the second image may be any correction processing as long as the correction processing is adjustment related to color adjustment, such as profile creation, tone curve adjustment, engine adjustment, and controller calibration.

As described above, in the image forming apparatus 2, the correction processing is performed based on the color measurement information on the color measurement portion extracted from the extraction device 100, and thus the color adjustment with respect to the color variation over time in the print job is performed.

The storage device 3 is, for example, a cloud server or the like and stores information on the color measurement of the first image transmitted from the extraction device 100 via a known network. The information on the color measurement of the first image may include, for example, color measurement history information such as information on the colorimetric value of the color measurement portion of the first image, information indicating whether or not the difference between the colorimetric value and the reference value exceeds an allowable range, and information indicating the difference between the colorimetric value and the reference value.

The analysis device 4 is a device that analyzes the attention degree from a human based on the image information and extracts a portion that the human pays attention to (attention portion) from the image information. The analysis device 4 includes an input section 4A, an output section 4B, and an analysis control section 4C.

The input section 4A acquires the image information based on the image date of the printing job from the extraction device 100 via the network and inputs it to the analysis control section 4C. In the present embodiment, the image information is information (raster image processor (RIP) image) obtained by converting image data of a print job for image formation. Note that the input section 4A may acquire image data of a print job from the image forming apparatus 2.

The output section 4B outputs, to the extraction device 100, information on the attention portion extracted based on the result of the analyzing of the attention degree from a human given to the image information by the analysis control section 4C.

The analysis control section 4C includes a CPU, a ROM, a RAM, and the like. The CPU reads a program according to processing contents from the ROM, develops the program in the RAM, and cooperates with the developed program to centrally control an operation of each block and the like of the analysis device 4. An analysis control section 4C analyzes the attention degree from a human based on the feature amount of an image in image information inputted by an input section 4A.

Specifically, the analysis control section 4C extracts a feature amount based on human sensitivity from the image information. The feature amount based on human sensitivity is, for example, a low-order image feature amount and a high-order image feature amount.

The low-order image feature amount is, for example, a physical image feature amount including color, luminance, orientation (the direction and shape of an edge), and the like, and is a component that guides the line of sight of a person to externally and passively gaze. The low-order image feature amount may be a concept widely including at least one of a color, a luminance distribution, a contrast, a face, a font, and a motion. The impact given to a person who views an image and the degree of attentiveness (conspicuousness or saliency) vary depending on factors such as the color (e.g., complementary color difference) used for each portion forming the image, the distribution of brightness (luminance) of each portion, the azimuth (direction), and the contrast.

For example, in a portion having a large difference in complementary color (e.g., a boundary portion between red and green, a boundary portion between blue and yellow, or the like), the line of sight of a human tends to concentrate and the saliency tends to increase. In addition, for example, in a case where there is a portion which branches in the vertical direction in an object which extends in the horizontal direction as a whole, there is a tendency for the line of sight of a person to concentrate on the portion. Further, when there is a portion recognized as a face in an image, a person generally tends to gaze at the portion. Further, when an element constituting an image is a character, the degree of gaze of a viewer varies depending on the type and size of a font. A font includes characters of a particular style of writing, and exists in a variety of styles, such as print, block, cursive, etc. The attention degree of a viewer may vary depending on the font used for expression. Further, even in the same style, a large character tends to attract more attention than a small character.

The high-order image feature amount is a physiological and mental image feature amount that reflects human memory, experience, knowledge, and the like, and is a component that guides the line of sight of a person so that the person naturally and actively gazes. Specifically, the high-order image feature amount is a component derived from a mental and psychological tendency of a human, a movement tendency of a line of sight, and the like which are considered to affect an impact given to a person who views an image and a degree of gaze (conspicuousness or saliency). The high-order image feature amount may include a degree of at least one of a position bias and processing fluency.

For example, the position bias affects the degree of gaze of a person who views an image, and may be a concept including “center bias” in which the line of sight tends to concentrate on an object at the center of an image as the tendency of the movement of the line of sight of a person. In addition, the position bias may be a concept including a tendency that, for example, in a magazine, a web page, or the like, the line of sight of a person is likely to move from the upper left to the lower right of an image and the line of sight is likely to concentrate on the upper left. Furthermore, the position bias may be a concept including a tendency that, when a vertically written document is viewed, the line of sight of a person moves from the upper right toward the lower left and the line of sight is likely to concentrate on the upper right. In addition, the position bias may be a concept including a tendency that the line of sight of a person tends to concentrate on a portion close to the height of the eyes in the layout of the store in a supermarket or the like.

The processing fluency generally means that a human can easily process a simple thing or an easily recognizable thing, and a human cannot easily process a complicated thing or an incomprehensible thing. For example, a portion which is easily recognized in an image and has a high processing fluency tends to be easily gazed by a person because the person's line of sight is easily directed thereto. In addition, a portion which is difficult to recognize and has low processing fluency in an image tends to be difficult for a person's line of sight to face and not to be gazed at.

The degree of processing fluency may be determined by at least one of complexity, density of design, and spatial frequency. The portion that is difficult to recognize is a portion that is messy and complicated, or a portion that is difficult to understand due to dense design or the like. In an image, a sudden change such as an edge occurs in the image in a portion or the like where designs or the like are crowded in a disorderly manner, and such a portion has a high spatial frequency. Therefore, the processing fluency is low at such a portion. In addition, it is difficult for a person to read information in a portion where information is not included, such as a portion where the complexity, the design density, or the spatial frequency is too low, and the portion tends not to be gazed at.

The analysis control section 4C calculates the attention degree of each portion in the image based on the low-order image feature amount and the high-order image feature amount described above. The analysis control section 4C may, for example, calculate each of the low-order image feature amount and the high-order image feature amount and assign weights to the calculated values and add the weighted values to obtain a value based on the sum as the attention degree.

Hereinafter, it is assumed that the low-order image feature amount is based on a color difference between adjacent regions and the high-order image feature amount is a position bias related to a center bias. In addition, the weighting coefficient is set to 0.5 for the low-order image feature amount and 0.5 for the high-order image feature amount.

The low-order image feature amount is a score of any one of 1 to 5. The analysis control section 4C calculates the low-order image feature amount, for example, such that the score increases as the color difference increases.

The high-order image feature amount is a score of any one of 1 to 5. The analysis control section 4C calculates the high-order image feature amount such that, for example, the score increases as the position in the image becomes closer to the center.

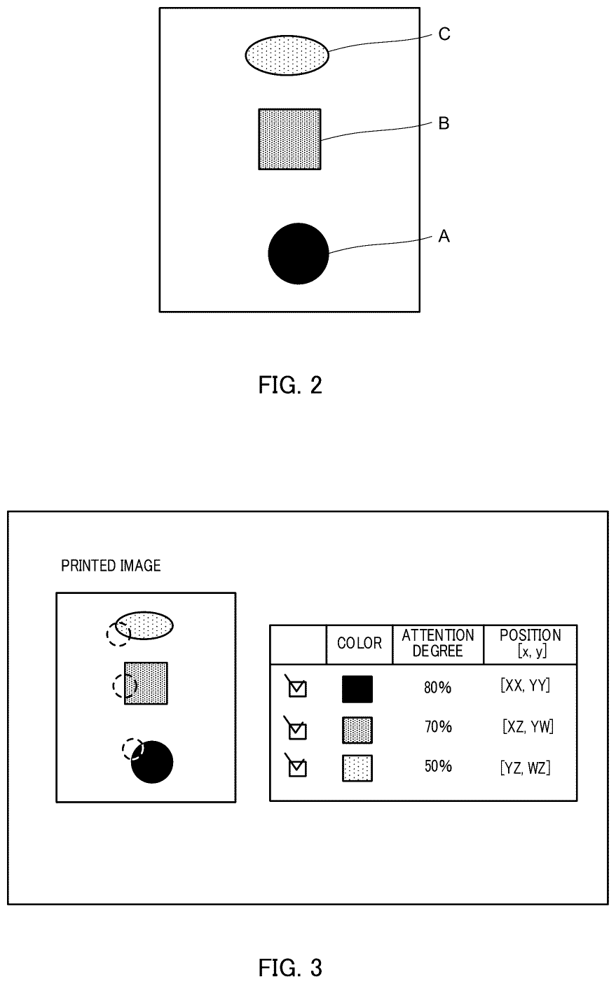

For example, as illustrated in FIG. 2, it is assumed that there is an image in which objects A, B, and C exist. It is assumed that the background color of the image is white, the object A is black, the object B is lighter in color than the object A, and the object C is lighter in color than the object B. The object A is located in a lower central portion in the image, the object B is located near the center in the image, and the object C is located above the object B in the image.

Since the color difference of the object A with respect to the background color is extremely large, the analysis control section 4C sets the low-order image feature amount to 5. In addition, since the object A is positioned in the lower central portion of the image, the analysis control section 4C sets the high-order image feature amount to 3. The analysis control section 4C multiplies each of the low-order image feature amount and the high-order image feature amount by a weighting coefficient (0.5), and adds the multiplied values together. The addition value in this case is 4 (namely, 5×0.5+3×0.5). Then, the analysis control section 4C sets the ratio of the maximum value (5) of the score to the added value as the attention degree. The attention degree given to the object A is 80%.

Since the color difference of the object B with respect to the background color is smaller than that of the object A, the analysis control section 4C sets the low-order image feature amount to 2. Further, since the object B is positioned near the center of the image, the analysis control section 4C sets the high-order image feature amount to 5. In this case, the sum of the values obtained by multiplying the image feature amounts by the respective weighting coefficients is 3.5 (namely, 2×0.5+5×0.5), and the attention degree given to the object B is 70%.

Since the color difference of the object C with respect to the background color is smaller than that of the object B, the analysis control section 4C sets the low-order image feature amount to 1. Furthermore, since the object C is located higher than the object B in the image, the analysis control section 4C sets the high-order image feature amount to 4. The sum of the values obtained by multiplying the image feature amounts by the respective weighting coefficients in this case is 2.5 (namely, 1×0.5+4×0.5), and the attention degree of the object C is 50%.

In this way, the analysis control section 4C calculates the attention degree of each portion in the image. Note that the low-order image feature amount may include feature amounts related to luminance and azimuth in addition to the color difference. Furthermore, the high-order image feature amount may include feature amounts related to position bias and processing fluency other than the center bias. Furthermore, the value of the weighting coefficient may be different between the low-order image feature amount and the high-order image feature amount.

Note that the low-order image feature amount and the high-order image feature amount are given as examples of the feature amount based on human sensitivity, but there is no limitation to this. For example, the image feature amount may be one of the low-order image feature amount and the high-order image feature amount, or may be an image feature amount other than the low-order image feature amount and the high-order image feature amount.

The analysis control section 4C controls the output section 4B so as to output, to the extraction device 100, the information on the attention portion for which the attention degree has been calculated. The information on the attention portion includes information on the color corresponding to the attention portion, information on the position corresponding to the attention portion in the image, and information on the attention degree of the attention portion.

Note that the analysis control section 4C may calculate the attention degree with respect to all portions in the image, or may calculate the attention degree with respect to portions other than portions where it is difficult for human attention to be focused (for example, portions where both the low-order image feature amount and the high-order image feature amount are 1).

Next, the extraction device 100 will be described.

As illustrated in FIG. 1, the extraction device 100 is a device that extracts a color measurement portion in an image formed by the image forming apparatus 2 based on information on a portion where a human pays attention to (i.e., attention portion by a human) in image information. The extraction device 100 is, for example, a computer device such as a personal computer and includes a CPU, a ROM, a RAM, and the like. In the extraction device 100, the CPU reads a program according to processing contents from the ROM, develops the program in the RAM, and cooperates with the developed program to centrally control an operation of each block and the like of the extraction device 100. The extraction device 100 includes a communication section 110, a display processing section 120, an extraction section 130, and a storage processing section 140.

The communication section 110 is a part that transmits and receives information to and from an external device through a network. The communication section 110 receives image information based on predetermined image data from the image forming apparatus 2, and transmits the received image information to the analysis device 4. Note that the image information converted into the RIP image is transmitted to the analysis device 4, but the conversion into the RIP image may be performed by the image forming apparatus 2 or the extraction device 100.

Then, the communication section 110 receives (acquires), from the analysis device 4, information on the attention portion analyzed by the analysis device 4 based on the image information. The communication section 110 corresponds to an “acquirer” according to the present invention.

The display processing section 120 performs processing for displaying, on the display device, the information on the attention portion acquired from the analysis device 4. The display device may be, for example, in a case where the extraction device 100 has a display section, the display section, or may be a display device provided separately from the extraction device 100.

Specifically, the display processing section 120 controls the information on the attention portion to be subjected to display processing based on the information on the attention portion. For example, the display processing section 120 displays the information on the attention portion on the display device in descending order of the attention degree.

For example, in the example illustrated in FIG. 2, the display processing section 120 arranges and displays the information on the attention portion related to the object A, the information on the attention portion related to the object B, and the information on the attention portion related to the object C in descending order of the attention degree, as illustrated in FIG. 3. In the example illustrated in FIG. 3, pieces of information on each attention portion are displayed on the display device in such a way that information on the color of the attention portion, information on the attention degree, and information on the position of the attention portion are displayed side by side.

By doing so, it becomes easy for the user to identify which portion is an attention portion having a high attention degree.

Further, the display processing section 120 superimposes and displays information indicating an attention portion on the image. For example, FIG. 3 illustrates an example in which circles surrounding the attention portions are displayed in the image.

In this way, the user can easily identify the position of an attention portion in the image.

Furthermore, the display processing section 120 may perform control so as to display, on the display device, information on an attention portion having an attention degree equal to or higher than a predetermined threshold and not to display, on the display device, information on an attention portion having an attention degree lower than the predetermined threshold. The predetermined threshold may be a value that can be appropriately set, such as 65%, for example. In addition, the predetermined threshold may be changeable by a user changing the setting of the extraction device 100.

In this way, it is possible to omit the display of an attention portion having a low attention degree.

The extraction section 130 extracts a color measurement portion of the image formed by the image forming apparatus 2, based on the information on the attention portion. Specifically, the extractor 130 extracts, as the information on the color measurement portion, the attention portion selected by the user from among all the attention portions acquired from the analysis device 4.

For example, the selection by the user may be performed via an operation section (not illustrated) of the extraction device 100, for example, by checking at least one of the check boxes displayed corresponding to pieces of information on the attention portions displayed on the screen of the display device.

Furthermore, the extraction section 130 may automatically extract, as the information on a color measurement portion, the information on the attention portion equal to or more than the predetermined threshold among all the attention portions acquired from the analysis device 4.

The communication section 110 transmits information on a color measurement portion extracted by the extraction section 130 to the image forming apparatus 2. The information on the color measurement portion includes information on the attention degree, information on the color of the color measurement portion, and information on the position of the color measurement portion.

As described above, in the image forming apparatus 2 that has acquired the information on the color measurement portion, the correction processing of the second image to be formed after the first image is executed based on the color measurement information on the color measurement portion of the first image.

In addition, the communication section 110 acquires the information on the color measurement of the first image from the image forming apparatus 2. Next, the storage processing section 140 executes storage processing of the acquired information on the color measurement of the first image into the storage device 3 via the communication section 110. The storage processing section 140 corresponds to a “first storage processor” of the present invention.

The information on the color measurement of the first image may be stored in the storage device 3 via the communication section 110 and the storage processing section 140 every time the color measurement is performed by the image forming apparatus 2. Alternatively, after the completion of the print job, all the information on the color measurement may be stored in the storage device 3 via the communication section 110 and the storage processing section 140.

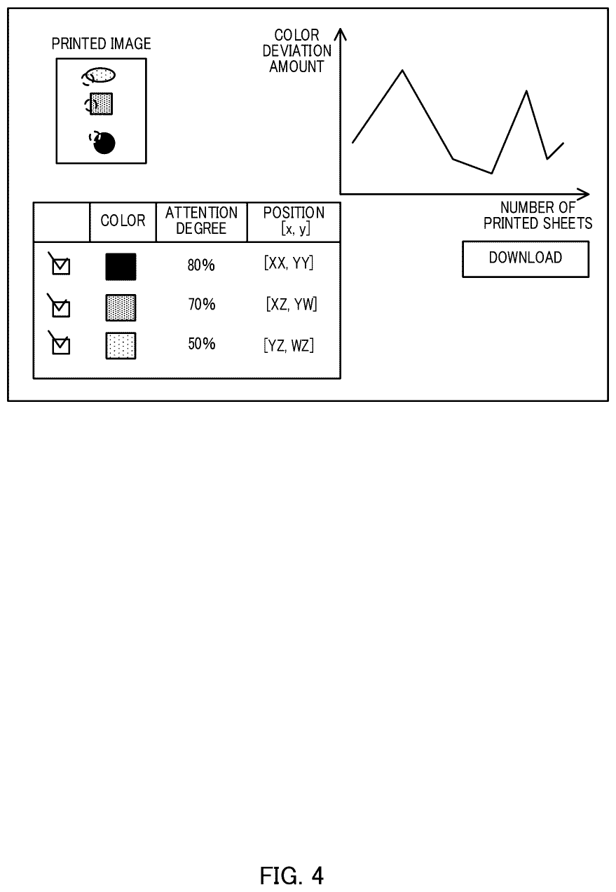

In addition, the display processing section 120 may display information regarding the color measurement of the first image on the display device. The information displayed on the display device may be, for example, information indicating the relationship between the difference (color deviation amount) between the colorimetric value and the reference value and the number of printed sheets (or the elapsed printing time). FIG. 4 illustrates an example in which information indicating a graph with the vertical axis thereof representing the color deviation amount and the horizontal axis thereof representing the number of printed sheets is displayed together with information on the attention portions.

Furthermore, the information related to the color measurement of the first image displayed on the display device may enable a user to acquire the information based on a user operation. For example, FIG. 4 illustrates an example in which the user can operate a button labeled “Download” to enable the user to acquire the information. The information acquired by the user may include related information such as the information on the allowable range and the reference information.

Accordingly, the user can easily confirm the information regarding the color measurement.

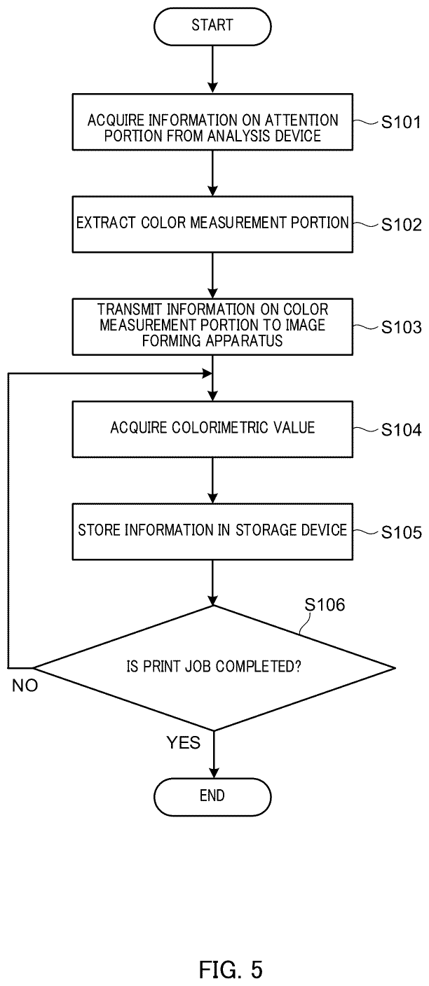

An operation example of extraction control in the extraction device 100 configured as described above will be described. FIG. 5 is a flowchart illustrating an operation example of extraction control in the extraction device 100. Note that the flowchart illustrated in FIG. 5 is executed as appropriate when a print job is executed and image information is input to the analysis device 4.

As illustrated in FIG. 5, the extraction device 100 acquires information on attention portions from the analysis device 4 (step S101). After acquiring information on the attention portions, the extraction device 100 extracts a color measurement portion from the information on the attention portions (step S102).

After the extraction of the color measurement portion, the extraction device 100 transmits information on the color measurement portion to the image forming apparatus 2 (step S103). After the information on the color measurement portion is transmitted and the print job is started, the extraction device 100 acquires the colorimetric value (step S104).

After the acquisition of the colorimetric value, the extraction device 100 stores information on the colorimetric value in the storage device (step S105). After storing in the storage device, the extraction device 100 determines whether or not the print job has ended (step S106).

As a result of the determination, when the print job is not completed (step S106, NO), the processing returns to step S104. On the other hand, when the print job is completed (step S106, YES), the present control ends.

According to the present embodiment configured as described above, a color measurement portion of an image formed on the basis of image data by the image forming apparatus 2 is extracted on the basis of information on a portion where a human pays attention to in image information based on the image data.

As a result, it is possible to set the color measurement portion to be extracted as a portion to which a human pays attention. Since the color variation of the portion to which a human pays attention has a high degree of recognition by a human, in the present embodiment, the portion having the high degree of recognition by a human can be set as the color measurement portion. As a result, an appropriate color measurement portion can be extracted.

Since the correction processing of the second image is executed by the image forming apparatus 2 using such a color measurement portion, it is possible to accurately correct a portion having a high degree of recognition by a human in the image.

In addition, since the information on the attention portion is acquired from the analysis device 4 that analyzes the attention degree from a human on the basis of the feature amount based on the human sensitivity in the image information, it is possible to extract the color measurement portion in consideration of the sensitivity of the human.

For example, in a case where analysis is performed based on artificial intelligence, statistical data is required, and thus there is a possibility that an accurate approach cannot be made in analysis of the attention degree to new image data.

In contrast, in the present embodiment, the attention degree from a human is analyzed on the basis of a feature amount based on the human sensitivity in image information, and thus it is possible to take an accurate approach in the analysis of the attention degree even for new image data.

In addition, since the image information is the RIP image obtained by converting the image data for image formation, for example, as compared with a configuration in which the attention portion is extracted from the image formed on the recording medium, the deviation of each position and each color of the image is small. As a result, it is possible to accurately extract the information on the attention portion from the image information.

Since the information on the attention portion is displayed on the display device, the user can grasp the information on the attention portion. In addition, since a color measurement portion is extracted based on the information on attention portions displayed on the display device, the color measurement portion and the portion grasped by the user can be matched with each other, and consequently, the portion can be appropriately corrected.

In addition, since the display processing section 120 controls information on an attention portion to be subjected to display processing based on the information on the attention portion, it is possible to omit display of a portion which has a low attention degree and which is not gazed at by a human.

Furthermore, since the storage processing section 140 executes the storage processing of the information on the color measurement of the first image in the storage device 3, the information on the color measurement of the first image can be left as the color measurement history information. As a result, after a print job is completed, information such as color variation based on color measurement can be provided to the user.

Note that although in the above-described embodiment, the image forming apparatus 2 performs processing related to correction processing, such as calculation of the difference between the color measurement information and the reference information, the present invention is not limited thereto. For example, processing related to the correction processing may be performed in the extraction device 100.

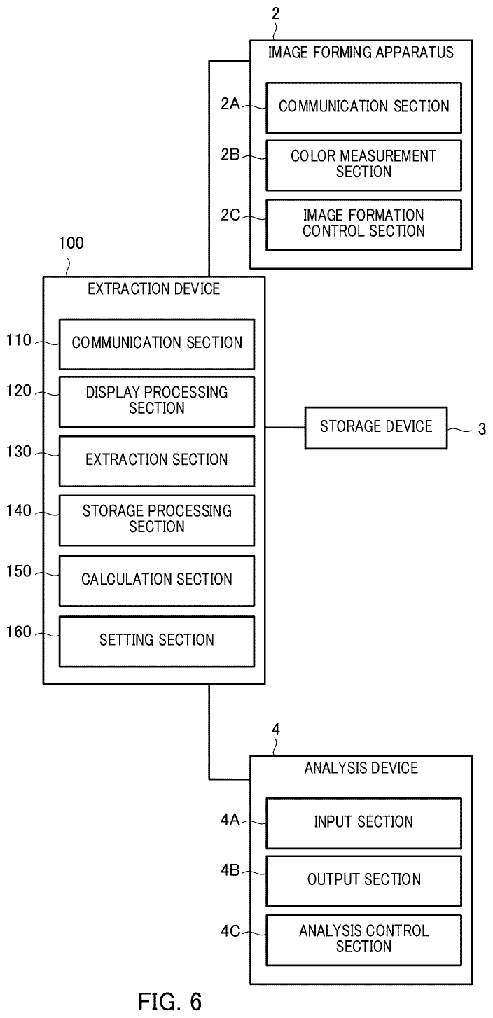

As illustrated in FIG. 6, the extraction device 100 according to this configuration includes a calculation section (i.e., calculator) 150 and a setting section 160 in addition to the configuration illustrated in FIG. 1.

The calculation section 150 calculates a difference between the color measurement information on the first image and the reference information. The calculation section 150 corresponds to a “first calculator” of the present invention.

The setting section 160 is a part for setting processing related to the correction processing of the image forming apparatus 2 in the extraction device 100. When the difference calculated by the calculation section 150 exceeds the above-described allowable range, the setting section 160 makes correction settings for the image forming apparatus 2. Specifically, the setting section 160 provides the image forming apparatus 2 with the setting for the correction processing for the second image via the communication section 110.

Thus, the correction setting of the image forming apparatus 2 can be performed from the extraction device 100.

In addition, the allowable range may be changeable by the user operating the setting section 160. In this way, it is possible to easily change the reference of the correction processing of the second image according to the intention of the user. The setting section 160 corresponds to a “first setter” of the present invention.

Furthermore, the above-described allowable range may be changeable for each attention degree of each color measurement portion. That is, the setting section 160 may set the allowable range for each of the plurality of color measurement portions.

For example, in a case where the attention degree is 80% or more, the setting section 160 sets the allowable range to be less than the color deviation amount of 3. The color deviation amount is, for example, an absolute value of a difference between a color value and a value corresponding to a reference value. When the attention degree is within a range of 50 to 80%, the setting section 160 sets the allowable range to a color deviation amount of less than 5. When the attention degree is less than 50%, the setting section 160 sets the allowable range to a color deviation amount of less than 7.

For example, in a case where the difference between the colorimetric value and the reference value is 3 in a color measurement portion where the attention degree is 80 percent or more, the difference exceeds the color deviation amount (less than 3) which is the allowable range, and thus the color measurement portion is corrected. In addition, in a case where the difference between the colorimetric value and the reference value is 3 in a color measurement portion where the attention degree is less than 50%, the difference does not exceed the color deviation amount (less than 7) which is the allowable range, and thus the color measurement portion is not corrected.

Thus, since the allowable ranges of respective color measurement portions can be made different from each other according to the attention degree, it is not necessary to perform correction on a color measurement portion having a relatively low attention degree with the same criterion as that for a color measurement portion having a relatively high attention degree. As a result, it is possible to suppress useless correction of the image data of the color measurement portion having a low attention degree.

When the difference calculated by the calculation section 150 is not within the allowable range, the display processing section 120 displays information indicating the fact on the display device to notify the user of the information. The information may be text information to be displayed on a display device of the extraction device 100. The display processing section 120 corresponds to a “first notifier” according to the present invention.

As a result, the user can easily grasp the information on the difference between the colorimetric value and the reference value. Furthermore, based on the information on the difference, the user determines whether the correction is to be performed and changes the setting of correction via the setting section 160, so that the degree of freedom in correction of the second image can be improved.

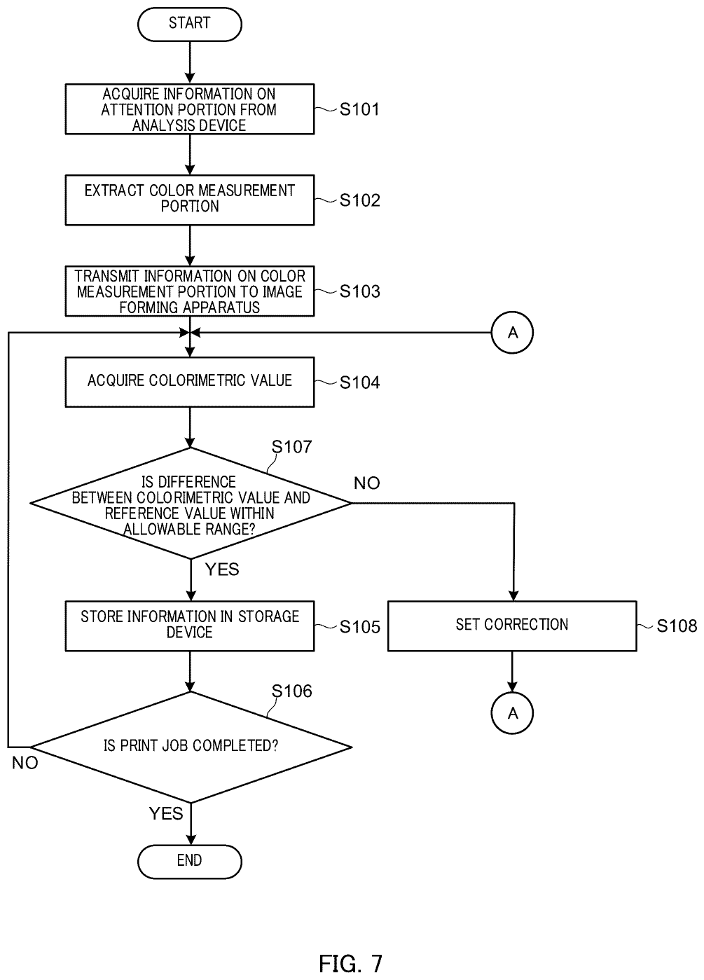

An operation example of extraction control in the extraction device 100 according to a modification example configured in such a manner will be described. FIG. 7 is a flowchart illustrating an operation example of extraction control in the extraction device 100 according to the modification example. Note that the flowchart illustrated in FIG. 7 is executed as appropriate when a print job is executed and image information is input to the analysis device 4. Furthermore, in the flowchart illustrated in FIG. 7, the processes of steps S101 to S106 are the same as those in the flowchart illustrated in FIG. 5.

As illustrated in FIG. 7, after step S104, the extraction device 100 determines whether a difference between the colorimetric value and the reference value is within an allowable range (step S107). As a result of the determination, when the difference is within the allowable range (step S107, YES), the process proceeds to step S105.

On the other hand, when the difference is not within the allowable range (NO in step S107), the extraction device 100 sets correction of image data in the image forming apparatus 2 (step S108). After step S108, the process returns to step S104.

In the above-described embodiment, the color measurement interval of the color measurement section 2B is set in advance, but the present invention is not limited thereto. For example, the extraction device 100 may calculate the color measurement interval.

Specifically, the calculation section 150 calculates the color measurement interval in the print job of the image forming apparatus 2 based on the attention degree of the attention portion corresponding to the color measurement portion. Specifically, the calculation section 150 calculates the color measurement interval such that the color measurement interval becomes shorter as the attention degree becomes higher. The calculation section 150 corresponds to a “second calculator” of the present invention.

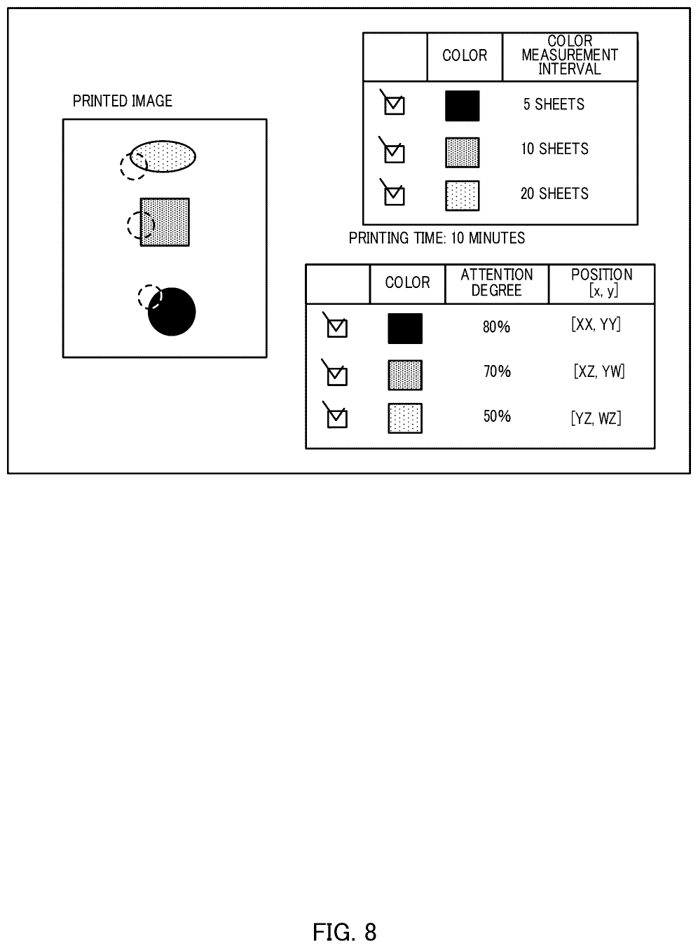

For example, in the example illustrated in FIG. 8, since the object A has the highest attention degree, the calculation section 150 calculates the color measurement interval to be 5 sheets. Since the attention degree of the object B is lower than that of the object A, the calculation section 150 calculates the color measurement interval to be 10 sheets. In addition, since the object C has the lowest attention degree, the calculation section 150 calculates the color measurement interval to be 20 sheets. The calculation of the color measurement interval may be performed by, for example, referring to a table or the like in which color measurement intervals associated with attention degrees are described.

Accordingly, since the timing of the color measurement for color measurement portions is changed according to the attention degrees of the color measurement portions, it is possible to increase the color measurement frequency of a portion having a relatively high attention degree while decreasing the color measurement frequency of a portion having a relatively low attention degree. As a result, it is possible to increase the efficiency of color measurement compared to a configuration in which color measurement is performed on all color measurement portions for one color measurement.

Further, the calculation section 150 may calculate the estimated time of printing of the print job based on the calculated color measurement interval. The estimated time is calculated, for example, based on the following Expression (1).

Estimated time=time until operation of the color measurement section of the image forming apparatus+moving time of the color measurement section in the main scanning direction+moving time in the sub-scanning direction+color measurement time+time taken from printing to output without color measurement operation (1)

The estimated time is a time corresponding to a time for printing, color measurement, and output of one sheet of the recording medium. The moving time of the color measurement section in the main scanning direction is the sum of the moving times when the color measurement section moves in the main scanning direction each for a color measurement portion. The moving time in the sub-scanning direction is the sum of the times required for conveying the recording medium in the sub-scanning direction for the color measurement. The color measurement time is the sum of the color measurement times each for a color measurement portion.

Information other than the moving time of the color measurement section in the main scanning direction may be acquired from the image forming apparatus 2 via the communication section 110. The moving time of the color measurement section in the main scanning direction may be calculated based on past print information from the storage device 3. For example, the calculation section 150 selects, from the print information in the past print jobs, print information in which the number of color measurement portions of the image in the new print job is the closest and the print information in which the positions of the color measurement portions of the image in the new print job are the closest. Then, from the selected print information, the calculation section 150 selects print information having the smallest difference value between the estimated time in the past print job and the printing time actually required for the print job.

The calculation section 150 acquires the position information on the color measurement portion from the selected past print information, and calculates the moving time of the color measurement section in the main scanning direction. The moving time is calculated based on the following Expression (2).

Movement time of the color measurement section in the main scanning direction of the past print job=|actually taken printing time−(time until the color measurement operation+moving time in the sub-scanning direction+color measurement time+time taken from printing to output without color measurement operation)|· (2)

Since the moving time in the sub-scanning direction of Expression (2) is the time for conveying the recording medium, it is information that the image forming apparatus 2 has, but it may be calculable by the extraction device 100. The moving time in the sub-scanning direction can be calculated by, for example, dividing the distance from the upper portion of the printing medium to the color measurement portion by the speed at which the printing medium passes through the color measurement section 2B.

The calculation section 150 calculates the moving speed of the color measurement section in the main scanning direction in the past print job based on the moving time calculated by Expression (2). The moving speed is calculated based on the following Expression (3).

The moving speed of the color measurement section in the main scanning direction in the past print job=the moving distance of the color measurement section in the main scanning direction/the past moving time of the color measurement section in the main scanning direction (3)

The calculation section 150 calculates the moving time of the color measurement section in the main scanning direction in the new print job based on the moving speed calculated by Expression (3). The moving time is calculated based on the following Expression (4). Moving distance of the color measurement portion in the main scanning direction of Expression (4) is calculated based on the color measurement portion in the new print job.

The moving time of the color measurement section in the main scanning direction in the new print job=the moving distance of the color measurement section in the main scanning direction/the moving speed of the color measurement section in the main scanning direction in the past print job.

Note that the moving time of the color measurement section in the main scanning direction for calculating the estimated time may be calculated based on information acquired from the image forming apparatus 2. For example, information such as the moving time described above may be calculated by outputting an image for time calculation using the image forming apparatus 2 before a print job.

The image for time calculation may be an image used in a print job or a predetermined chart image.

The storage processing section 140 may execute processing, to store in the storage device 3, of the color measurement interval and the estimated time (information regarding the color measurement interval) calculated by the calculation section 150. The information relating to the color measurement interval may include position information on the color measurement portion in addition to the color measurement interval and the estimated time. The storage processing section 140 corresponds to a “second storage processor” of the present invention.

Thus, the estimated time of the new print job can be left as a history, which can be used as a past estimated time when an estimated time for a further new print job is calculated.

A user may be able to set the printing time of a print job via the setting section 160. In this case, the calculation section 150 may calculate the color measurement interval based on the printing time set by the user.

As a result, it is possible to set the color measurement interval suitable for the printing time desired by the user.

Furthermore, the display processing section 120 may display the color measurement interval calculated by the calculation section 150 on a display device to notify a user of information on the color measurement interval. Furthermore, the display processing section 120 may also notify the user of information on the estimated time in addition to the color measurement interval. For example, FIG. 8 illustrates an example in which color measurement intervals and printing times (estimated times) are displayed. The display processing section 120 corresponds to a “second notifier” according to the present invention.

In this way, the user can grasp the color measurement interval and the estimated time.

The display processing section 120 may notify the user of not only the color measurement interval and the estimated time but also the maximum printing time in the case where the color measurement is performed for all the color measurement portions.

Since the user is notified of the maximum printing time, the user can understand that the printing time will be shortened to some extent by the color measurement interval and the estimated time.

The user may also change the color measurement portion or change the color measurement interval via the setting section 160. The setting section 160 corresponds to a “second setter” of the present invention. In addition, in a case where the user changes the color measurement interval, the calculation section 150 may calculate the estimated time for the printing again based on the changed color measurement interval.

In addition, the information on the color measurement interval calculated by the calculation section 150 as described above is set to the color measurement interval of the color measurement section 2B of the image forming apparatus 2 via the communication section 110. After the color measurement interval is set, a print job is performed. In addition, color measurement is performed at the set color measurement interval in the print job. Furthermore, after completion of the print job, the storage processing section 140 executes processing of storing the actually taken printing time in the storage device 3.

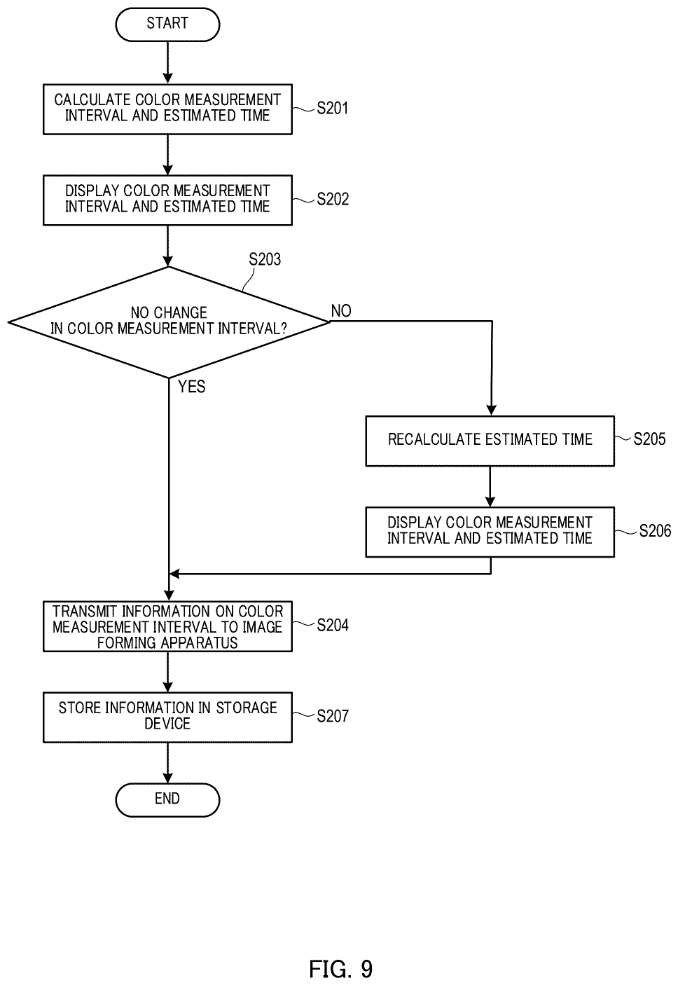

An operation example of the color measurement interval calculation control in the extraction device 100 according to a modification example configured in such a manner will be described. FIG. 9 is a flowchart illustrating an operation example of color measurement interval calculation control in the extraction device 100 according to a modification example. Note that the flowchart illustrated in FIG. 9 is executed as appropriate when information on an attention portion is acquired from the analysis device 4.

As illustrated in FIG. 9, the extraction device 100 calculates a color measurement interval and an estimated time (step S201). After calculating the color measurement interval and the estimated time, the extraction device 100 displays the calculated color measurement interval and estimated time (step S202).

After displaying the color measurement interval and the estimated time, the extraction device 100 determines whether or not the color measurement interval has been changed (step S203). As a result of the determination, in a case where the color measurement interval is not changed (step S203, YES), the extraction device 100 transmits information on the color measurement interval to the image forming apparatus 2 (step S204).

On the other hand, when the color measurement interval has been changed (NO in step S203), the extraction device 100 calculates the estimated time again based on the changed color measurement interval (step S205).

After the estimated time is calculated again, the extraction device 100 displays the color measurement interval and the estimated time (step S206). After step S206, the processing proceeds to step S204.

After step S204, the extraction device 100 allows the storage device 3 to store the calculated color measurement interval and estimated time (step S207). After step S207, the present control ends. After the print job by the image forming apparatus 2 is completed, the extraction device 100 may acquire the information on the actually required printing time and store the information in the storage device 3.

Furthermore, the calculation section 150 may calculate the color measurement interval based on information other than the information on the attention degree, in addition to the information on the attention degree. For example, the calculation section 150 may calculate the color measurement interval based on the color measurement history information of the image forming apparatus 2 in addition to the information on the attention degree. The color measurement history information is, for example, information indicating a difference between a colorimetric value of a predetermined color and a reference value and information associated with the information indicating the difference. The information associated with the information indicating the difference may be, for example, information on the number of printed sheets when the difference between the colorimetric value and the reference value exceeds an allowable range.

Specifically, the calculation section 150 extracts, for the color of each color measurement portion of the current print job, information on the number of printed sheets when a difference between the colorimetric value of a color equivalent to the aforementioned color and the reference value exceeds the allowable range, from the color measurement history information. The calculation section 150 extracts the CMYK value for the color of the extracted information, and based on the features of the C value, the M value, the Y value, and the K value, groups the pieces of information of the numbers of printed sheets for the features, and sorts the groups in ascending order of the number of printed sheets.

For example, assume that a group including a color having a C value of 100%, a group including a color having an M value of 80%, and a group including a color having a C value of 60% are sorted in ascending order of the number of printed sheets.

The calculation section 150 calculates, as a color measurement interval, an interval that further reduces the color measurement interval calculated based on the information about the attention degree for a color measurement portion associated with a group including a color having a C value of 100%, which is a group having the smallest number of printed sheets. For example, when the color measurement interval calculated based on the information on the attention degree is 30 sheets, an interval (for example, 15 sheets) smaller than the interval is set as the color measurement interval.

Further, in this case, the calculation section 150 may set the color measurement interval so that the difference between the estimated time and the estimated time calculated based on only the information on the attention degree does not exceed a predetermined time.

The color measurement interval in this case may be settable by the user via the setting section 160.

Furthermore, the display processing section 120 may display, on the display device, information indicating that a color in which the difference between the colorimetric value and the reference value tends to exceed the allowable range is included in a color measurement portion or information indicating that the color measurement interval has become smaller, to notify the user of the information.

Further, in the above-described embodiment, the storage device 3 stores the information on the color measurement of the first image (information on the attention portion) and the like, but may store job information on the print job. That is, the storage processing section 140 may associate the information on an attention portion with the job information of the image forming apparatus 2 and execute the storage processing to the storage device 3. The storage processing section 140 corresponds to a “third storage processor” of the present invention.

The job information includes various information such as image information, information on the color of the image (CMYK values, L*a*b* values, and the like), the type of the recording medium, the type of the image forming apparatus 2, the attention degree, the user name, and the job name, for example.

Furthermore, when information on an attention portion analyzed by the analysis device 4 is notified to the user as a color measurement portion via the extraction device 100, there may be a difference between the color measurement portion and the portion that the user has actually paid attention to. This is because, for example, when a recording medium having a special background color such as a transparent film is used, the color of an image formed on the recording medium may change.

For example, it is assumed that the user pays the most attention to the object B among the object A, the object B, and the object C in the image illustrated in FIG. 2. However, as in the above-described example, in a case where the analysis device 4 determines the attention degree of the object B to be lower than the attention degree of the object A, a difference occurs between the analysis result of the analysis device 4 and the attention portion from the user.

In this case, the user may set the attention degree to a color measurement portion via the setting section 160 or the like. This setting may be performed, for example, by the user inputting the attention degree via the setting section 160.

The extraction section 130 extracts an attention portion corresponding to the user's setting as a color measurement portion. That is, the extraction section 130 changes, according to the setting by the user, the information on the attention portion acquired from the analysis device 4 from before the setting by the user. Next, the extraction section 130 feeds back the changed information to the analysis device 4 via the communication section 110.

When the changed information is fed back from the extraction device 100, the analysis device 4 may change the setting of the analysis so as to utilize the fed back information for the next analysis. When a print job similar to the print job as the feedback target is analyzed, the setting of the analysis may be a setting suitable for the content changed by the user, for example, the setting of the weighting coefficient or the like is changed from the normal setting.

Examples of the similar print job include a job having the same user name as that of the print job serving as the feedback target and a job having the same color of the color measurement portion as that of the print job serving as the feedback target.

Furthermore, based on the fed back information, the analysis device 4 may store information on the attention portions whose attention degrees have been changed by the user, and may analyze similar print jobs based on a list of the stored information.

In addition, in a case where the analysis device 4 has performed analysis based on the fed back information, a list of the above-described stored information (past job information) may be displayed on the display device of the extraction device 100.

In addition, in a case where the changed information is fed back, the analysis device 4 may perform re-analysis of the attention portion based on the fed back information and output the result to the extraction device 100.

Although information on an attention portion by a human in image information is acquired from the analysis device 4 in the embodiment described above, the present invention is not limited thereto. For example, the information acquired by the extraction device 100 with reference to a table in which a boundary part between two different colors in an image is associated with a result of a questionnaire on how easy it is for a plurality of evaluators to pay attention to the boundary part, the questionnaire being based on a five level evaluation or the like, may be acquired as the information on a portion where a human pays attention to. The questionnaire result may be an average value, a median value, or the like of the evaluation points given by each of the plurality of evaluators.

Furthermore, in the above embodiment, the display processing section 120 provides a display on the display device to notify the user of information, but the present invention is not limited to this. For example, the user may be notified of information by sound outputted by a sound output section.

Furthermore, although the storage processing in the storage device 3 is executed by the extraction device 100 in the above embodiment, the present invention is not limited thereto and the storage processing may be executed by the image forming apparatus 2.

Furthermore, although the storage processing section is provided in the above-described embodiment, the present invention is not limited thereto, and the storage processing section does not have to be provided, for example, when no storage device is provided.

In the above-described embodiment, the image information is an RIP image, but the present invention is not limited thereto. For example, the image information may be information on a read image obtained by reading a printed image based on image data.

Further, in the above-described embodiment, the extraction device 100 is a device separate from the image forming apparatus 2, but the present invention is not limited thereto, and the extraction device 100 may be a device included in the image forming apparatus.

In addition, each of the above-described embodiments is merely an example for embodying the present invention, and the technical scope of the present invention should not be interpreted in a limited manner by these embodiments. That is, the present invention can be implemented in various forms without departing from the spirit or main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. An extraction device, comprising:
a hardware processor that acquires information on an attention portion by a human in image information based on image data, wherein
the hardware processor extracts, based on the information on the attention portion, a color measurement portion of an image formed by an image forming apparatus based on the image data.

2. The extraction device according to claim 1, wherein:
the hardware processor acquires the information on the attention portion from an analysis device; and
the analysis device performs analysis on an attention degree from the human based on a feature amount based on human sensitivity in the image information, and outputs the information on the attention portion to the extraction device based on a result of the analysis.

3. The extraction device according to claim 1, wherein
the image forming apparatus executes, based on color measurement information on the color measurement portion of a first image formed on a recording medium, correction processing of a second image that is formed on a recording medium later than the first image, the second image being based on the same image data as the first image.

4. The extraction device according to claim 1, wherein
the image information is information obtained by converting the image data for image formation.

5. The extraction device according to claim 1, wherein:
the hardware processor performs, on a display device, display processing of the acquired information on the attention portion; and
the hardware processor extracts the color measurement portion based on the information on the attention portion displayed on the display device.

6. The extraction device according to claim 5, wherein
the hardware processor controls the information on the attention portion to be subjected to the display processing, based on the information on the attention portion.

7. The extraction device according to claim 3, wherein:
the hardware processor acquires the color measurement information on the first image;
the hardware processor calculates a difference between the color measurement information on the first image and reference information; and
when the difference is not within an allowable range, the hardware processor notifies a user of information indicating that the difference is not within the allowable range.

8. The extraction device according to claim 7, wherein
the hardware processor sets the allowable range.

9. The extraction device according to claim 8, wherein:
the color measurement portion includes a plurality of color measurement portions; and
the hardware processor sets the allowable range for each of the plurality of color measurement portions.

10. The extraction device according to claim 7, wherein
the hardware processor executes processing of storing information in a storage device, the information relating to color measurement of the first image.

11. The extraction device according to claim 3, wherein:
the hardware processor calculates a color measurement interval in a print job of the image forming apparatus based on the attention degree of the attention portion corresponding to the color measurement portion.

12. The extraction device according to claim 11, wherein
the hardware processor calculates an estimated time for printing of the print job.

13. The extraction device according to claim 11, wherein
the hardware processor notifies a user of the calculated color measurement interval; and
the hardware processor sets the color measurement interval.

14. The extraction device according to claim 11, wherein
the hardware processor executes processing of storing information in a storage device, the information relating to the color measurement interval in the print job.

15. The extraction device according to claim 11, wherein
the hardware processor calculates the color measurement interval based on, in addition to the attention degree, color measurement history information of the image forming apparatus.

16. The extraction device according to claim 11, wherein
the image forming apparatus includes a color measurer that measures a color of a printed image obtained by print processing according to the print job;
the hardware processor outputs information on the calculated color measurement interval to the image forming apparatus; and
the image forming apparatus controls the color measurer based on the information on the color measurement interval.

17. The extraction device according to claim 1, wherein
the hardware processor associates the information on the attention portion with job information on the image forming apparatus and executes processing of storing the information in a storage device.

18. The extraction device according to claim 2, wherein:
the hardware processor changes, according to setting by a user, the information on the attention portion acquired from the analysis device, from before the setting by the user; and
the hardware processor feeds back the changed information to the analysis device.

19. An extraction method by an extraction device, the method comprising:
acquiring information on an attention portion by a human in image information based on image data; and
extracting, based on the information on the attention portion, a color measurement portion of an image formed by an image forming apparatus based on the image data.

20. A non-transitory computer-readable recording medium storing an extraction program to be executed by an extraction device, the extraction program causing a computer to execute:
processing of acquiring information on an attention portion by a human in image information based on image data; and
processing of extracting, based on the information on the attention portion, a color measurement portion of an image formed by an image forming apparatus based on the image data.
